(19) United States
(12) Patent Application Publication
(10) Pub. No.: US 2026/0296691 A1
(43) Pub. Date: Oct. 1, 2026

(54) TRANSPORTATION DRONE

(71) Applicant: Sang-Mook LEE, Namyangju-si (KR)

(72) Inventor: Sang-Mook LEE, Namyangju-si (KR)

(21) Appl. No.: 19/479,240

(22) PCT Filed: Apr. 17, 2024
(86) PCT No.: PCT/KR2024/005119

§ 371 Date: Oct. 27, 2025

(30) Foreign Application Priority Data
Apr. 28, 2023 (KR) 10-2023-0056278

(51) Int. Cl. B64U 60/10; B64C 25/56; B64U 10/14; B64U 30/24; B64U 30/293; B64U 30/294; B64U 60/40; B64U 101/60

(52) U.S. Cl. CPC B64U 60/10; B64C 25/56; B64U 60/40; B64U 10/14; B64U 30/24; B64U 30/293; B64U 30/294; B64U 2101/60

(57) ABSTRACT

A transportation drone, comprising a main body having a wing unit formed at an upper portion and a transportation space formed at a lower portion through which a transportation object, such as an automobile, can be transported in and out in a front-to-rear direction; and a buoyancy unit having a plurality of tubes coupled to the lower portion of the main body such that the plurality of tubes can be inflated and deflated by air pressure. In such a configuration, the tubes, which are inflated and deflated by air pressure along the lower periphery of the main body, are coupled. The tubes can be seated on the surface of the water through buoyancy by inflating and deflating sequentially and can be made to float on the surface of the water by inflating and deflating sequentially when overturning on the surface of the water, thereby preventing flooding accidents.

### TECHNICAL FIELD

The present invention relates to a transportation drone, and more particularly, to a transportation drone combined with a transportation object, such as a vehicle, to travel together with the transportation object, or used to transport the transportation object by flight.

### BACKGROUND ART

Recently, a drone, which originated in the military industry, refers to a flight vehicle having an airplane or helicopter shape that flies by radio frequency guidance without a human being on board.

Recently, drones are widely used for military and commercial purposes, and research thereon is also actively being conducted.

However, due to the increasing demand for drones, the amount of drone traffic in the airspace is anticipated to increase, and accordingly the possibility of collisions and rear-ends during flights of drones has increased. In addition, the possibility of drone crashes is also increasing due to reasons such as poor drone control, battery discharge, and malfunction. In addition, the above-mentioned increasing risks due to using drones may lead to damage to life or property.

In addition, in recent years, the drones have been used in various fields such as logistics delivery, disaster relief, broadcasting and leisure, in addition to military use, due to various advantages such as simplicity, rapidity, and economic feasibility.

However, the existing drones may be not only unable to transportation objects such as automobiles, but also fail to transportation objects in bad weather conditions.

In addition, a crash may occur due to waves or strong winds during flight over air routes, thereby causing a submersion accident.

The related art in the technical field to which the present invention pertains includes, for example, Korean Patent Registration No. 10-2314218, Korean Patent Registration No. 10-2133412, Korean Patent Registration No. 10-1866191 and Korean Patent Registration No. 10-2328509.

### DISCLOSURE

### Technical Problem

The present invention is proposed to solve the above conventional problems, an object of the present invention is to provide a drone capable of transporting transportation objects such as automobiles and capable of transporting the transportation objects even in bad weather conditions such as strong winds.

In addition, an object of the present invention is to provide prevent a drone from falling into water and causing a flooding accident during flights over air routes

### Technical Solution

In order to achieve the above-mentioned objects, a transportation drone according to a preferred embodiment of the present invention includes: a main body having an upper portion formed therein with a wing unit and a lower portion formed therein with a transportation space through which a transportation object, such as an automobile, is allowed to be transported in and out in a front-and-rear direction; and a buoyancy unit having a plurality of tubes coupled to a lower end of the main body so as to be inflated and deflated by air pressure.

In addition, supports may be coupled to both sides of the transportation space of the main body, a moving wheel may be coupled to a lower end of the support so as to be drawn in and out, and a support plate may be coupled between lower portions of the supports so as to be movable in a vertical direction to have an adjustable height.

In addition, the support plate may be moved downward when the main body is positioned in front or rear of the transportation object and the moving wheel is drawn out, and may be moved upward when the transportation object is positioned above the support plate.

In addition, the tube of the buoyancy unit may have a gourd shape.

In addition, the buoyancy unit may be coupled with an adjustment cylinder so that each of the tubes is positioned to outward.

In addition, the tube may be positioned in a straight line in the vertical direction with respect to a propeller of the wing unit when being positioned outward.

In addition, the tube of the buoyancy unit may be rotatably coupled to the adjustment cylinder so as to be reversed up and down.

In addition, the body may be configured such that when the tubes are overturned on a water surface while being inflated, the tubes are sequentially deflated from a front of the main body to a rear thereof, and then when the main body is arranged vertically, the tubes are sequentially inflated again from the rear to the front.

### Advantageous Effects

According to the transport drone of the present invention, the support plate positioned below the transportation space is formed movably in the vertical direction to come into close contact with the bottom of a transportation object such as an automobile, so as to transport the transportation object by flight when the transportation object is combined with the transportation space, and also transport the transportation object by road driving, so that transportation can be facilitated even in situations impossible for flight.

In addition, the tubes inflated and deflated by the air pressure are coupled along a lower periphery of the main body and sequentially inflated and deflated, so as to be seated on a water surface through buoyancy, and float over the water surface by sequentially inflating and deflating when overturning on the water surface of the water, so that a flooding accident can be prevented.

### DESCRIPTION OF DRAWINGS

FIG. 1 is a perspective view of a transport drone according to a preferred embodiment of the present invention.

FIG. 2 is a side sectional view of the transport drone according to the preferred embodiment of the present invention.

FIG. 3 shows operation views of a moving wheel and a support plate according to the preferred embodiment of the present invention.

FIG. 4 shows operation views of a second tube according to the preferred embodiment of the present invention.

FIG. 5 shows operation views of the second tube according to the preferred embodiment of the present invention.

FIG. 6 shows layout views of a first wing unit and a second wing unit according to the preferred embodiment of the present invention.

FIGS. 7 to 9 are operation views of the first wing unit and the second wing unit according to the preferred embodiment of the present invention.

FIG. 10 shows operation views of flight wings according to the preferred embodiment of the present invention.

FIG. 11 is a view showing a state in which a driving arm is fixed to an angle fixing groove according to the preferred embodiment of the present invention.

FIG. 12 shows a front view and a bottom view of a sub-fixing groove according to the preferred embodiment of the present invention.

FIG. 13 shows a bottom view and a plan view of a fixing plate according to the preferred embodiment of the present invention.

FIG. 14 shows operation views of a shielding film according to the preferred embodiment of the present invention.

### BEST MODE

### Mode for Invention

Advantages and features of the present invention, and methods for achieving the advantages and features will be apparent with reference to the embodiments described below in detail with the accompanying drawings.

However, the present invention is not limited to the embodiments disclosed below and may be implemented in various different forms, and these embodiments are provided only to make the disclosure of the present invention complete and to fully inform a person having ordinary skill in the art of the scope of the present invention, and the present invention is defined only by the scope of the claims. The same reference numeral indicates the same element throughout the specification.

Hereinafter, the present invention will be described with reference to the drawings for illustrating a transportation drone according to the embodiments of the present invention.

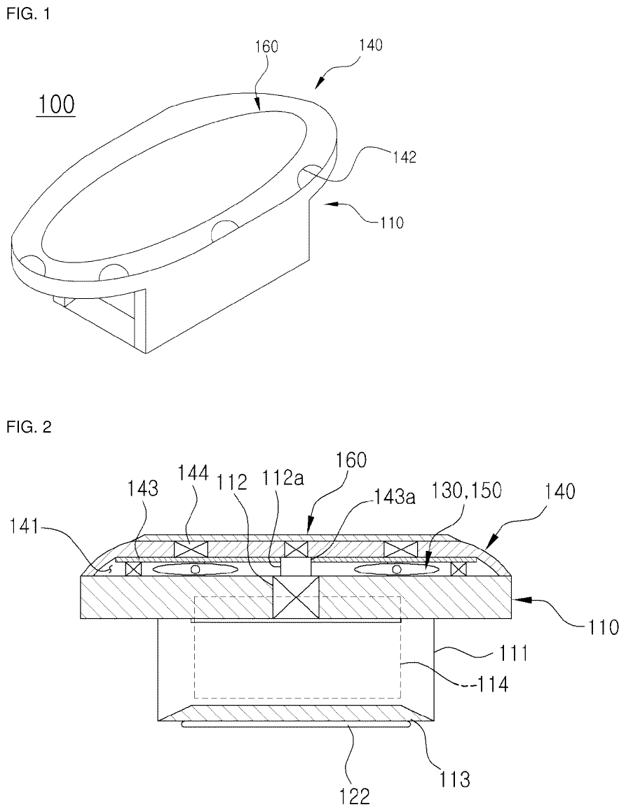

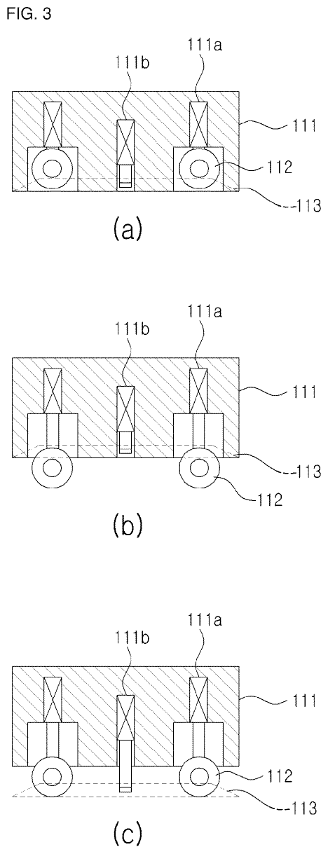

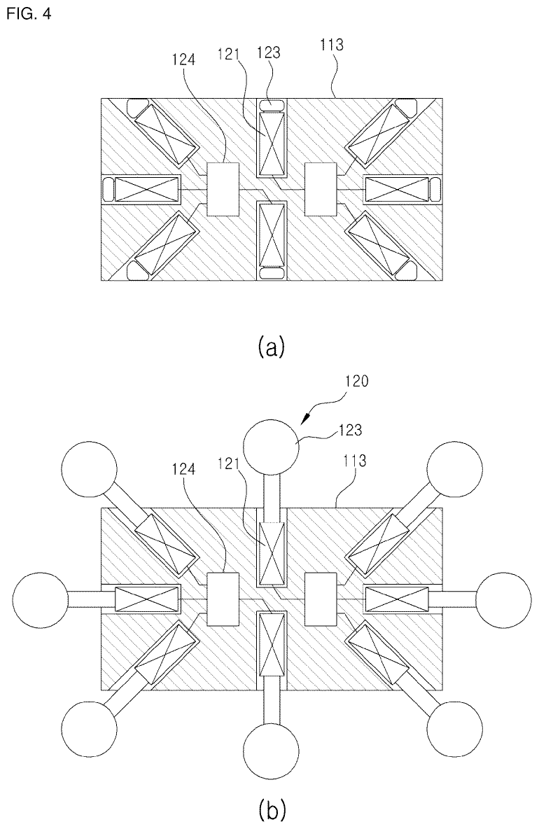

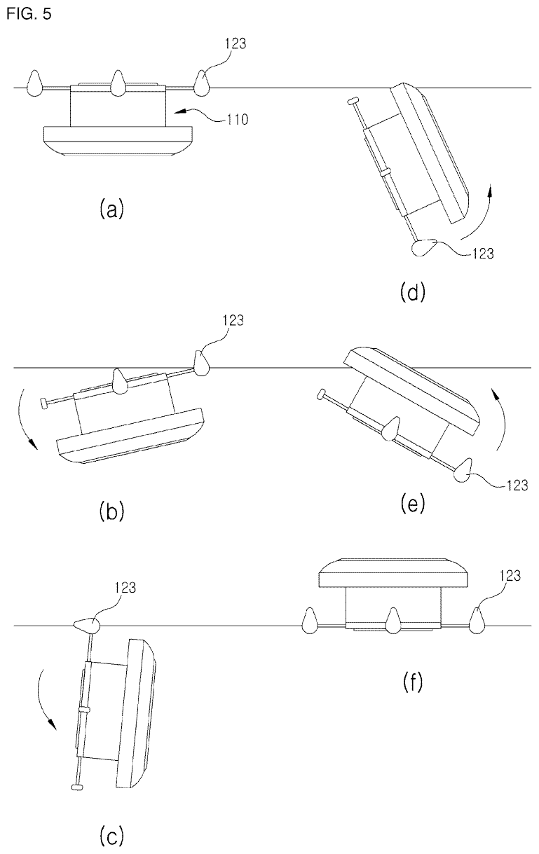

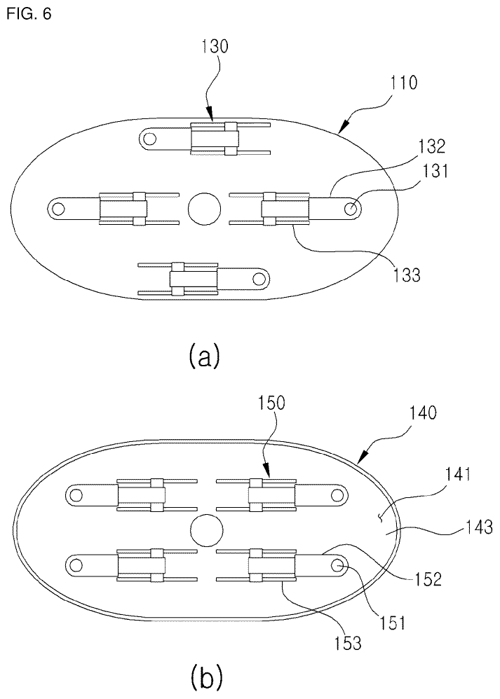

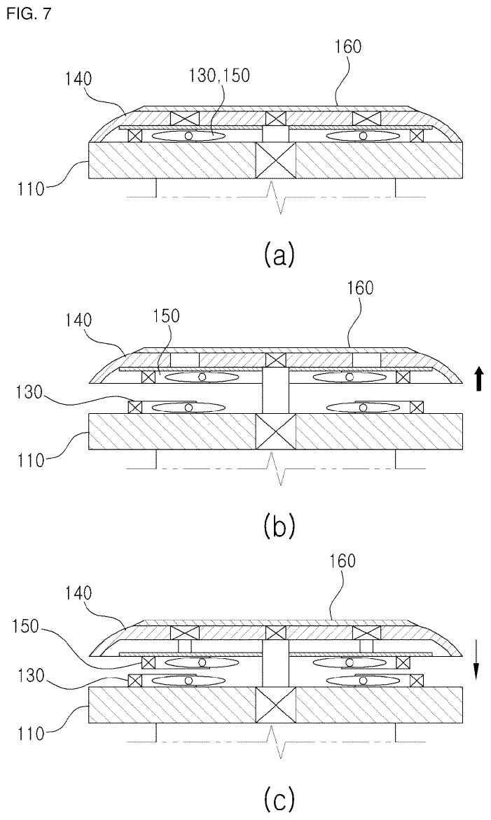

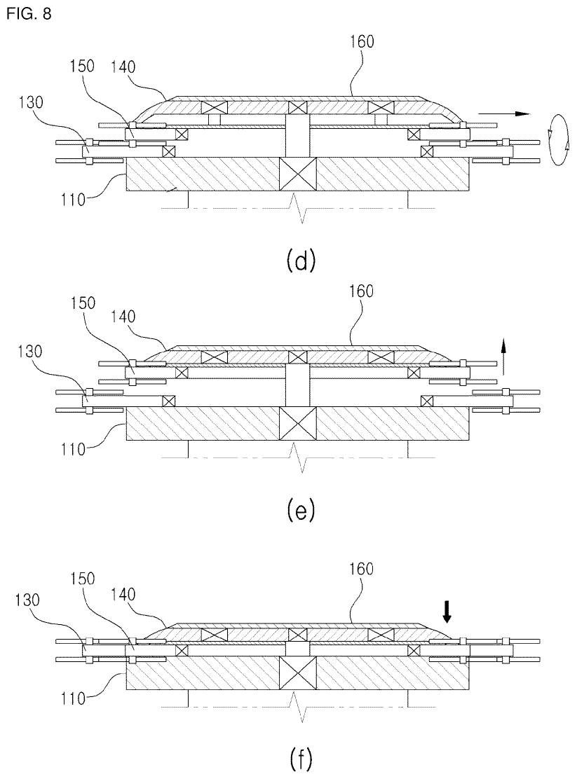

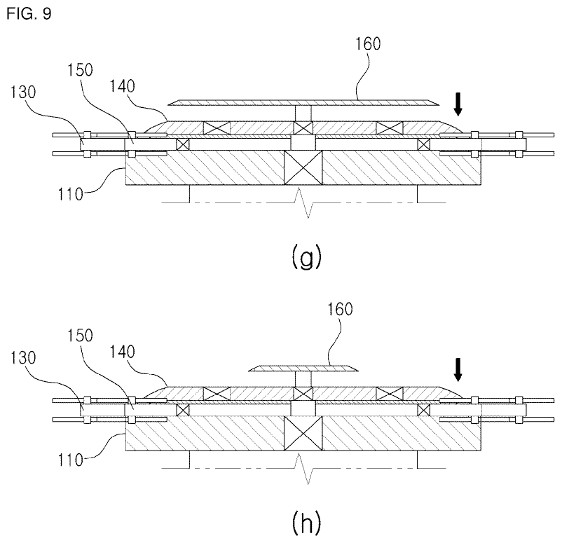

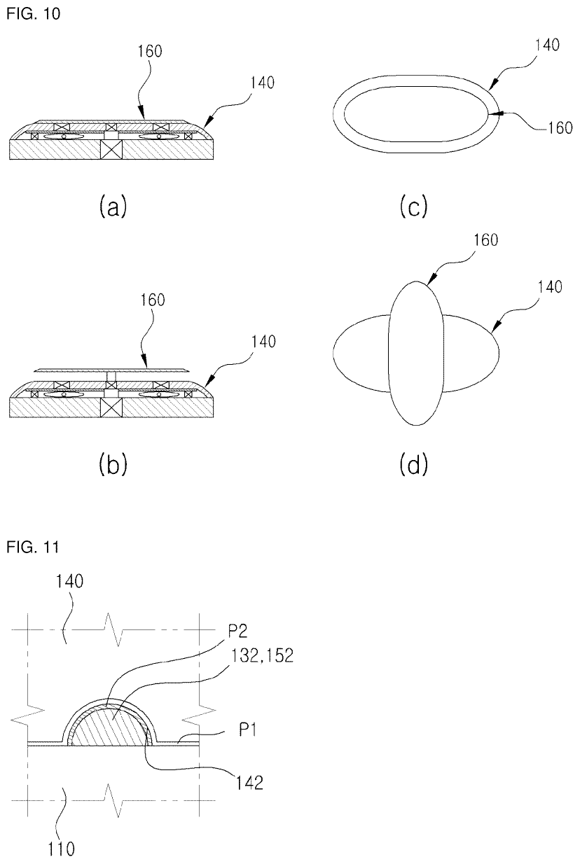

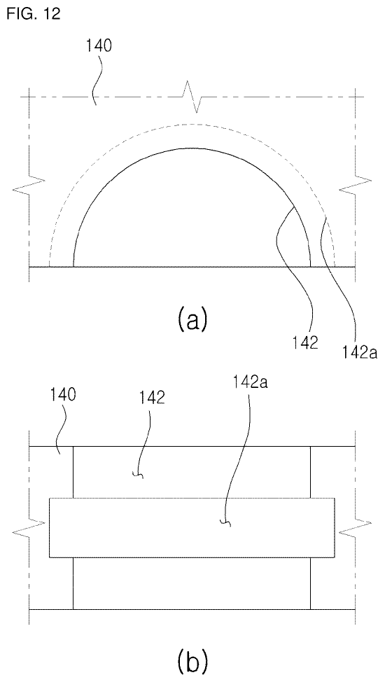

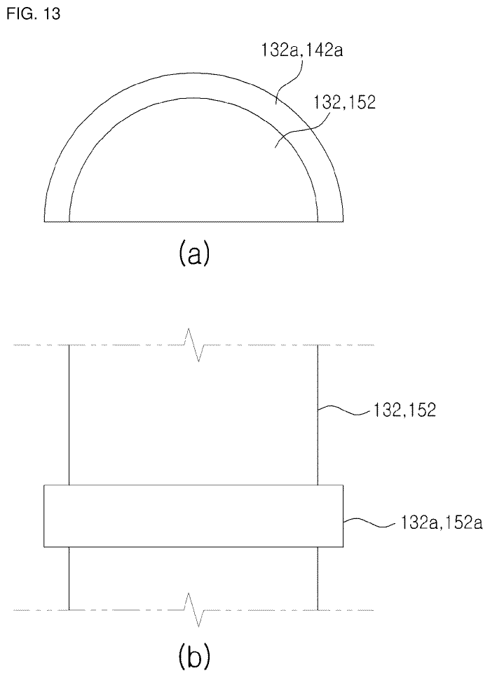

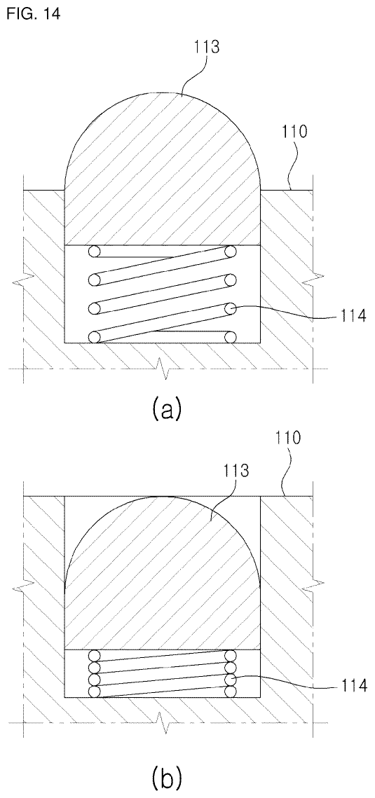

FIG. 1 is a perspective view of a transport drone according to a preferred embodiment of the present invention; FIG. 2 is a side sectional view of the transport drone according to the preferred embodiment of the present invention; FIG. 3 shows operation views of a moving wheel and a support plate according to the preferred embodiment of the present invention; FIG. 4 shows operation views of a second tube according to the preferred embodiment of the present invention; FIG. 5 shows operation views of the second tube according to the preferred embodiment of the present invention; FIG. 6 shows layout views of a first wing unit and a second wing unit according to the preferred embodiment of the present invention; FIGS. 7 to 9 are operation views of the first wing unit and the second wing unit according to the preferred embodiment of the present invention; FIG. 10 shows operation views of flight wings according to the preferred embodiment of the present invention; FIG. 11 is a view showing a state in which a driving arm is fixed to an angle fixing groove according to the preferred embodiment of the present invention; FIG. 12 shows a front view and a bottom view of a sub-fixing groove according to the preferred embodiment of the present invention; FIG. 13 shows a bottom view and a plan view of a fixing plate according to the preferred embodiment of the present invention; and FIG. 14 shows operation views of a shielding film according to the preferred embodiment of the present invention.

Referring to the drawings, the transport drone according to the present embodiment has the feature capable of transporting transportation objects such as automobiles, and preventing flooding accidents occurring during transportation via roads and air routes.

A transport drone 100 according to the present embodiment capable of providing the above advantageous effects includes a main body 110, a buoyancy unit 120, a first wing unit 130, a cover unit 140, and a second wing unit 150.

The main body 110 has a streamlined long shape and is formed in a large size to allow transport of transportation objects, such as automobiles, to be transported.

Supports 111 extending downward is coupled to both sides of the main body 110.

A first adjustment cylinder 111a and a second adjustment cylinder 111b are coupled inside the support 111.

A moving wheel 112 is coupled to a lower end of the support 111 so as to be drawn in and out by the first adjustment cylinder 111a.

The moving wheel 112 is drawn in and out from the lower end of the support 111 by the first adjustment cylinder 111a.

A support plate 113 is coupled between the lower portions of the supports 111 to have a height adjustable in a vertical direction by the second adjustment cylinder 111b.

The support plate 113 comes into close contact with a ground when being moved downward by the second adjustment cylinder 111b.

A transportation space is formed between the supports 111 in the main body 110.

The transportation space is formed through the main body 110 in a front and rear direction.

The transportation object is transported is the transportation space, in which the support plate 113 is moved downward and comes into contact with the ground while the moving wheel 112 being moved downward, the transportation object is moved and positioned above the support plate 113, and then the support plate 113 is lifted up.

Further, a battery 114 is coupled inside the support 111 of the main body 110.

The battery 114 may be detachably coupled to the support 111.

A first driving cylinder 115 is coupled to an upper portion of the main body 110.

A cylinder rod 115a is coupled to the first driving cylinder 115 to protrude upward from the main body 110.

The buoyancy unit 120 is configured to form buoyancy in the main body 110 and coupled to the support plate 113.

Specifically, the buoyancy unit 120 has a first tube 122 is coupled to a center of a lower surface of the support plate 113.

For example, the first tube 122 is formed in a mat shape.

A third adjustment cylinder 121 is coupled around a periphery of the buoyancy unit 120 at regular intervals.

A second tube 123 is coupled to an end of the third adjustment cylinder 121.

The second tube 123 is moved outward according to a drive of the adjustment cylinder 121.

For example, the second tube 123 has a gourd shape.

The second tube 123 is positioned in a straight line in the vertical direction with a first propeller 133 and a second propeller 153 described later when being moved outward.

The second tube 123 is rotatably coupled to the end of the third adjustment cylinder 121 so as be reversed in the vertical direction.

An air injection unit 124 is coupled to the buoyancy unit 120 so that air pressure is supplied to the first tube 122 and the second tube 123.

The air injection unit 124 is installed to one side of the lower surface of the support plate 113.

For example, the air injection unit 124 is formed by an air compressor.

The air injection unit 124 supplies constant air pressure to the first tube 122 and the second tube 123 when the main body 110 is placed on a water surface.

The air injection unit 124 deflates the second tubes 123 sequentially from the front to the rear so that the main body 110 is vertically arranged when the main body 110 capsizes on the water surface.

In addition, when the main body 110 is arranged vertically, the second tubes 123 are simultaneously inflated sequentially from the rear to the front to return the main body 110 to a normal state.

The second tubes 123 is not limited to be inflated sequentially from the rear to the front, and may be inflated from the front to the rear or in the left and right directions.

The first wing unit 130 is configured to provide thrust to the main body 110, coupled to an upper end of the main body 110, and connected to the battery 115.

The first wing unit 130 has a plurality of first driving motors 131 coupled on the upper surface of the main body 110 at regular intervals.

A body of the first driving motor 131 is coupled to be accommodated into the main body 110.

The first driving motors 131 are arranged along a periphery of the main body 110.

First driving arms 132 are rotatably coupled to the first driving motors 131, respectively.

The first driving arms 132 come close contact with the upper surface of the main body 110 so as to be supported.

Each of the first driving arms 132 is rotated to be positioned and drawn in the upper surface of the main body 110, or is rotated to be drawn outward from the upper surface of the main body 110.

A first propeller 133 is coupled to an end of the first driving arm 132.

The first propeller is doubly coupled to the first driving arm in the vertical direction.

The first driving arm may be preferably formed to have the end to be rotatable, so as to rotate the first propeller upon the drawn-in.

This is to prevent the first propellers doubly arranged in the vertical direction from interfering with the upper surface of the main body when the first driving arm coming into close contact with the upper surface of the main body is drawn in.

When being rotated to be drawn in the main body 110, the first driving arms 132 are arranged to be parallel to each other and arranged to be parallel to the longitudinal direction of the main body 110.

The cover unit 140 is configured to cover the first wing unit 130 drawn in, and is coupled to the main body 110 movably in the vertical direction thereof.

The cover unit 140 has a size corresponding to or the same as the upper surface of the main body 110.

A space portion 141 is formed at a bottom of the cover unit 140 to cover the first wing unit 130.

An angle fixing groove 142 is formed on a lower end periphery of the cover unit 140 at a position facing the first driving arm 132 of the first wing unit 130 having been drawn out so as to fix the first driving arm 132.

The angle fixing groove 142 is formed at a position facing the second driving arm 152 described later.

Further, a sub-fixing groove 142a is formed along an inner wall in the angle fixing groove 142.

A first fixing plate 132a and a second fixing plate 152a are formed on the first driving arm 132 and the second driving arm 152, respectively, so as to be coupled to the sub-fixing groove 142a at a position corresponding to the sub-fixing groove 142a.

The cover unit 140 is moved downward to cover the drawn-in first wing unit 130 through the space portion 141.

The cover unit 140 is moved upward to allow the first wing unit 130 to be drawn out.

After the first wing unit 130 is drawn out while the cover unit 140 being moved upward, the cover unit is moved downward to fix the first driving arm 132 through the angle fixing groove 142

In addition, a lower plate 143 is coupled to the space portion 141 of the cover unit 140 so as to be movable in the vertical direction.

Specifically, the lower plate 143 is formed to correspond to the space portion 141, and formed at a center thereof with a through-hole 143a through which the cylinder rod 116a passes.

The lower plate 143 is connected to a second driving cylinder 144 installed on an inner upper surface of the space portion 141.

The lower plate 143 is moved in the vertical direction within the space portion 141 according to a drive of the second driving cylinder 144.

The lower plate 143 is positioned to come into close contact with an upper end of the first wing unit 130 when the cover portion unit 140 is positioned downward.

The second wing unit 150 has the same configuration as the first wing unit 130, and is coupled to a lower surface of the lower plate 143 and connected to the battery 115.

The second wing unit 150 has a plurality of second driving motors 151 coupled to the lower surface of the lower plate 143 at regular intervals.

The second driving motor 151 is coupled to be accommodated in the lower plate 143.

The second driving motors 151 are arranged along a periphery of the lower plate 143.

The second driving motor 151 may be preferably arranged between the adjacent first driving motors 131 on the periphery of the lower plate 143.

Second driving arms 152 are rotatably coupled to the second driving motors 151, respectively.

The second driving arm 152 comes into close contact with the lower surface of the lower plate 143.

Each of the second driving arms 152 is rotated to be positioned and drawn in the lower surface of the lower plate 143, or is rotated to be drawn outward from the lower plate 143.

A second propeller 153 is coupled to an end of the second driving arm 152.

The first driving arm 132 and the second driving arm 152 may be preferably arranged to be spaced apart from each other at regular intervals.

This is to prevent the first propeller 133 and the second propeller 153 from interfering with each other during operation.

When being rotated to be drawn in the lower plate 143, the second driving arms 152 are arranged to be parallel to each other and arranged to be offset, when viewed from the top, to the first driving arms 132.

When the cover unit 140 is moved downward, the second driving arms 152, while being drawn in, are positioned between the first driving arms 132, and positioned to be on a plane with the first driving arms 132.

Meanwhile, the second propeller is doubly coupled to the second driving arm in the vertical direction.

The second driving arm may be preferably formed to have the end to be rotatable, so as to rotate the second propeller upon the drawn-in.

This is to prevent the second propellers doubly arranged in the vertical direction from interfering with the lower surface of the lower plate when the second driving arm coming into close contact with the lower surface of the lower plate is drawn in.

A flight wing 160 formed to correspond to a shape of the upper surface of the cover unit 140 is coupled to the upper surface of the cover unit 140.

The flight wing 160 is configured to maintain lift even when the propellers stops at a predetermined speed or higher, and is coupled to the upper surface of the cover unit 140 so as to be adjusted in height by a separate cylinder.

The flight wing 160 comes into close contact with the upper surface of the cover unit 140 to be superposed thereto or is raised to a predetermined height.

The flight wing 160 is rotatably coupled to the cover unit 140 by a separate motor.

The flight wing 160 has a rotation radius of 90 degrees and is arranged to face the cover unit 140 or protrude from both sides of the cover unit according to the rotation.

The flight wing 160 may be preferably driven when the drone flies at a predetermined speed.

In addition, a first packing member P1 is coupled to the lower periphery of the cover unit 140 so as to be tightly sealed against the upper surface of the main body 110 to suppress wind noise and prevent moisture and rainwater from entering inward.

Preferably, the first packing member P1 may also be formed in the angle fixing groove 142.

In addition, a second packing member P2 is coupled to the upper end of the first driving arm 132 and the lower end of the second driving arm 152.

The second packing member P2 reduces impact and suppresses noise when the first driving arm 132 comes into close contact with the lower plate 143 or when the second driving arm 152 comes into close contact with the main body 110.

A shielding film 113 is coupled to the upper surface of the main body 110 at a position facing the angle fixing groove 142 so as to be elastically drawn in and out, thereby shielding the angle fixing groove 142 when being drawn out.

An elastic body 114 is coupled to a lower end of the shielding film 113.

The shielding film 113 is drawn out upward by elasticity and drawn inward when being pressurized by external force.

The shielding film 113 has a semicircular shape so as to be pressed by an adjacent first driving arm 132 upon rotation of the adjacent first driving arm 132 and drawn into the main body 110

The first driving arm 132, the second driving arm 152 and the angle fixing groove are also formed to have the same shape.

According to the transport drone of the present invention, the support plate positioned below the transportation space is formed movably in the vertical direction to come into close contact with the bottom of a transportation object such as an automobile, so as to transport the transportation object by flight when the transportation object is combined with the transportation space, and also transport the transportation object by road driving, so that transportation can be facilitated even in situations impossible for flight.

In addition, the tubes inflated and deflated by the air pressure are coupled along a lower periphery of the main body and sequentially inflated and deflated, so as to be seated on a water surface through buoyancy, and float over the water surface by sequentially inflating and deflating when overturning on the water surface of the water, so that a flooding accident can be prevented.

It will be apparent that a person having ordinary skill in the art may carry out various deformations and modifications within the scope without departing from the idea of the present invention, the following claims and equivalents thereof. Therefore, the above-described embodiments will be understood in all respects as illustrative and not restrictive. The scope of the present invention is defined by the following claims rather than the above detailed description, and all deformations or modifications derived from the idea and scope of the claims and their equivalents will be construed as being included in the scope of the present invention.

1. A transportation drone comprising:
a main body having an upper portion formed therein with a wing unit and a lower portion formed therein with a transportation space through which a transportation object including an automobile is allowed to be transported in and out in a front-and-rear direction; and
a buoyancy unit having a plurality of tubes coupled to a lower end of the main body so as to be inflated and deflated by air pressure.

2. The transportation drone of claim 1, wherein supports are coupled to both sides of the transportation space of the main body, a moving wheel is coupled to a lower end of the support so as to be drawn in and out, and a support plate is coupled between lower portions of the supports so as to be movable in a vertical direction to have an adjustable height.

3. The transportation drone of claim 2, wherein the support plate is moved downward when the main body is positioned in front or rear of the transportation object and the moving wheel is drawn out, and is moved upward when the transportation object is positioned above the support plate.

4. The transportation drone of claim 1, wherein the tube of the buoyancy unit has a gourd shape.

5. The transportation drone of claim 4, wherein the buoyancy unit is coupled with an adjustment cylinder so that each of the tubes is positioned to outward.

6. The transportation drone of claim 5, wherein the tube is positioned in a straight line in the vertical direction with respect to a propeller of the wing unit when being positioned outward.

7. The transportation drone of claim 5, wherein the tube of the buoyancy unit is rotatably coupled to the adjustment cylinder so as to be reversed up and down.

8. The transportation drone of claim 7, wherein the body is configured such that when the tubes are overturned on a water surface while being inflated, the tubes are sequentially deflated from a front of the main body to a rear thereof, and then when the main body is arranged vertically, the tubes are sequentially inflated again from the rear to the front.
